(19) United States
(12) Patent Application Publication
(10) Pub. No.: US 2011/0124487 A1
(43) Pub. Date: May 26, 2011

(54) FORMATION VENTILATION GAS PURIFICATION COATING STRUCTURE USING INORGANIC MEMBRANE, AND METHOD FOR MANUFACTURING THEREOF

(75) Inventors: Byung Hoon Ryou, Seoul (KR); Jae Kyung Kong, Seoul (KR)

(73) Assignee: E.M.W. ENERGY CO., LTD., Seoul (KR)

(21) Appl. No.: 13/054,500

(22) PCT Filed: Jul. 16, 2008
(86) PCT No.: PCT/KR08/04163

§ 371 Date: Jan. 16, 2011

(51) Int. Cl. B01J 37/34; B01J 32/00; B01J 23/42; B01J 23/46

(52) U.S. Cl. 502/5; 502/439; 502/300; 502/339; 502/325

(57) ABSTRACT

A structure of a carrier used for exhaust gas purification using an inorganic membrane and a method of producing thereof, in which an inorganic membrane made with an alumina film is produced using anode oxidation and the inorganic membrane is applied to a carrier used for exhaust gas purification, whereby the carrier works in stability at all temperatures and shows a high performance when exhaust gas generated from an engine, such as hydrocarbon, carbon monoxide, nitrogen oxide, and so on, passes through a plurality of shells formed with inorganic membranes. For this, provided is a method of producing a carrier used for exhaust gas purification using an inorganic membrane, including the steps of: (a) applying anode current to each of carrier modules, and loading at least one carrier module in a water tank, in which an electrolyte is circulated and to which cathode current is applied; and (b) forming a porous inorganic membrane on the outer skin of the carrier module.

### CROSS REFERENCE TO RELATED APPLICATION AND CLAIM OF PRIORITY

The present application claims all benefits accruing under 35 U.S.C. §365(c) from the PCT International Application PCT/KR2008/004163, with an International Filing Date of Jul. 16, 2008, the entire contents of which are incorporated herein by reference.

### BACKGROUND

1. Field of the Invention

The present invention relates to a structure of a carrier used for exhaust gas purification using an inorganic membrane and a method of producing thereof.

2. Description of the Related Art

In general, a carrier used for exhaust gas purification is a ceramic carrier produced in such a way as to coat the carrier with the noble metals such as platinum, which is a catalyst for exhaust gas purification.

Hereinafter, referring to the drawings, a structure of a carrier used for exhaust gas purification according to a prior art and problems of the prior art will be described.

FIGS. 1 to 3 illustrate a structure of a carrier used for exhaust gas purification according to the prior art, and in the drawings, the reference numeral 3 designates the carrier.

The carrier 3 is made of a ceramic material. A mold case 21 for extruding the carrier 3 is formed, and a molded part 23 having a plurality of pores 25 and a plurality of porous walls 26 is formed inside the mold case 21.

Main materials of the carrier 3 is put into the mold case 21, and then, a pressurizing part 22 for applying power in a predetermined direction is formed.

That is, after the main material of the carrier 3 is put between the molded part 23 having the plural pores 25 and the pressurizing part 22 inside the mold case 21, when the pressurizing part 22 gives pressure in a predetermined direction, it passes the molded part 23 having the plural pores 25 and the plural porous walls 26, whereby the carrier 3 having a plurality of shells 4 is produced.

A cutting part 24 is formed on one side of the mold case 21, and a user can cut the carrier 3 having the plural shells 4 as long as he or she wants and use it.

In the drawings, the reference numeral 1 designates a case.

The case 1 includes a buffering part 2 formed therein to prevent that the carrier 3 having the plural shells 4 is pushed backward or broken under the pressure of exhaust gas.

Hereinafter, a production process of an exhaust gas purifier produced by the above according to the prior art will be described as follows.

First, put the main materials of the ceramic carrier 3 to the inside of the mold case 21, and then, carry out extrusion through the molded part 23 by applying a fixed power to the pressurizing part 22.

After the carrier 3 is formed inside the case 1, mount it to an exhaust pipe of an engine.

The purifier 30 produced as described above purifies exhaust gas discharged from the engine, namely, exhaust gas discharged through the exhaust pipe after hydrocarbon, carbon monoxide and nitrogen oxide are adsorbed on the carrier 3.

The carrier is mainly used to purify exhaust gas, and now, in order to increase the purification efficiency of the carrier, the carrier is formed in such a way as to have the shells reduced in size and the wall of the carrier reduced in thickness.

However, the prior arts have several problems as follows.

First, the carrier made of the ceramic material is weak to shock and is not good in durability.

Furthermore, in order to realize an exhaust gas purification efficiency more than 90% at temperature of 400° C., it is necessary that the carrier has a length of at least 30 cm, but, in case of two-wheel vehicles such as motorcycles, it is difficult to mount the carrier thereon since the carrier is too bulky. Moreover, due to the property of ceramics of high density, the ceramic carrier increases weight of the entire vehicle and it causes a reduction of fuel efficiency.

Additionally, due to the high production costs of ceramics, the carrier production costs are too high percentage of the overall costs in manufacturing a vehicle.

Moreover, in case of a carrier of more than 30 cm, the carrier decreases the exhaust gas purification efficiency because temperature lowers while exhaust gas of high temperature passes through the carrier and a low-temperature environment is formed toward an exist.

To solve the above problems, it is necessary to develop a carrier, which is reduced in production costs, is lightweight, and can obtain exhaust gas purification efficiency equal to or more than that of the prior arts despite of a short length.

### SUMMARY

Accordingly, at least one or more embodiments of the present invention has been made in an effort to solve the above-mentioned problems occurring in the prior arts, and it is an aspect of the present invention to provide a structure of a carrier used for exhaust gas purification using an inorganic membrane and a method of producing thereof, in which an inorganic membrane made with an alumina film is produced using anode oxidation and the inorganic membrane is applied to a carrier used for exhaust gas purification, whereby the carrier works in stability at all temperatures and shows a high performance when exhaust gas generated from an engine, such as hydrocarbon, carbon monoxide, nitrogen oxide, and so on, passes through a plurality of shells formed with inorganic membranes.

To accomplish the above object, according to one or more embodiments of the present invention, there is provided a method of producing a carrier used for exhaust gas purification using an inorganic membrane, including the steps of: (a) applying anode current to each of carrier modules, and loading at least one carrier module in a water tank, in which an electrolyte is circulated and to which cathode current is applied; and (b) forming a porous inorganic membrane on the outer skin of the carrier module.

Preferably, before the step (a), the method of producing a carrier used for exhaust gas purification further includes the steps of: carrying out etching to the carrier module with a basic solution to remove oxides existing in the carrier module; and carrying out desmut with a slightly acid solution to remove insoluble materials existing in the carrier module.

Furthermore, the electrolyte is a sulfuric acid solution or a basic solution.

Moreover, the method of producing a carrier used for exhaust gas purification further includes the step of loading a catalyst stock solution on the inner wall and the outer wall of the carrier module membrane to thereby form a catalytic layer.

Preferably, the catalytic layer is made of platinum or rhodium.

Additionally, catalytic layers of different kinds are formed on every carrier module.

In the meantime, the method of producing a carrier used for exhaust gas purification further includes the step of laminating at least one carrier module and mounting it in a case to form a carrier.

Furthermore, in another aspect of the present invention, provided is a structure of a carrier used for exhaust gas purification using an inorganic membrane, which is arranged on an exhaust gas discharge passage and has a plurality of pores formed for purifying exhaust gas.

Preferably, each of the pore is 10 μm to 150 μm in diameter.

Moreover, the inorganic film is 0.5 μm to 150 μm in thickness.

In addition, the carrier structure is formed by laminating at least one carrier module in the carrier, the carrier module having a sieve-shaped grid.

Preferably, the grid is formed inclinedly at a predetermined angle from a height direction that the carrier module is laminate.

Furthermore, on the surface of the grid, a metal layer forming a base, a transition layer which is formed on the metal layer and in which metals constituting the metal layer and oxides of the metals coexist, and a porous ceramic film layer formed on the transition layer are formed.

Moreover, a catalytic layer is inserted into the ceramic film layer.

Additionally, the catalytic layer is made of platinum or rhodium.

In the meantime, the carrier module is made of aluminum, titanium or zirconium.

As described above, according to one or more embodiments of the present invention, the inorganic membrane made with an alumina film is produced using anode oxidation and the inorganic membrane is applied to the carrier used for exhaust gas purification, whereby the carrier works in stability at all temperatures and shows a high performance when exhaust gas generated from an engine, such as hydrocarbon, carbon monoxide, nitrogen oxide, and so on, passes through a plurality of shells formed with inorganic membranes.

### BRIEF DESCRIPTION OF THE DRAWINGS

FIGS. 1 to 3 illustrate a structure of a carrier used for exhaust gas purification according to a prior art.

FIG. 4 is a process diagram for explaining a production process of an inorganic membrane according to a first embodiment of the present invention.

FIG. 5 illustrates a carrier having an inorganic membrane according to a second embodiment of the present invention.

FIG. 6 is a sectional view taken along the line of A-A′ of FIG. 5.

FIG. 7 is an enlarged view of the surface of a grid of FIG. 6.

FIG. 8 illustrates a method of producing the carrier having the inorganic membrane according to the second embodiment of the present invention.

FIG. 9 illustrates a production process of a carrier having an inorganic membrane formed according to a further embodiment of the present invention.

FIG. 10 illustrates a structure of the carrier having the inorganic membrane formed by the method illustrated in FIG. 9.

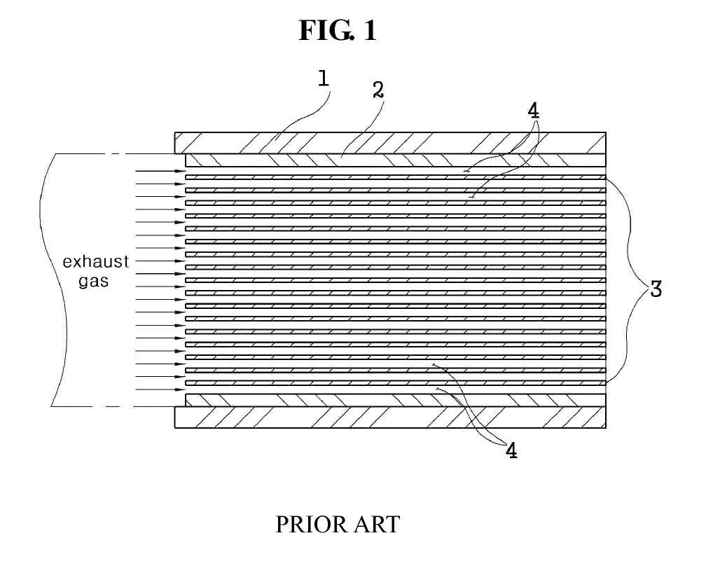

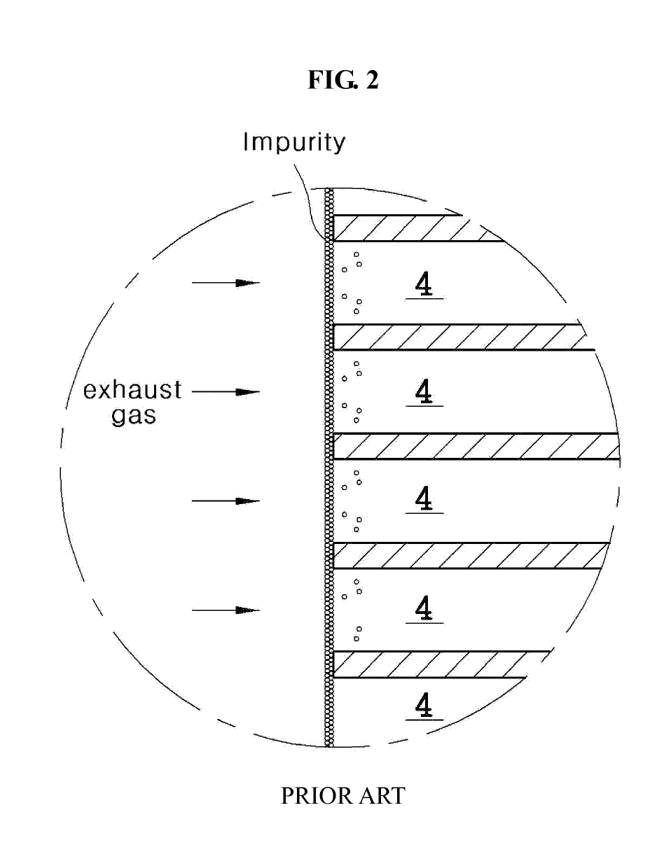

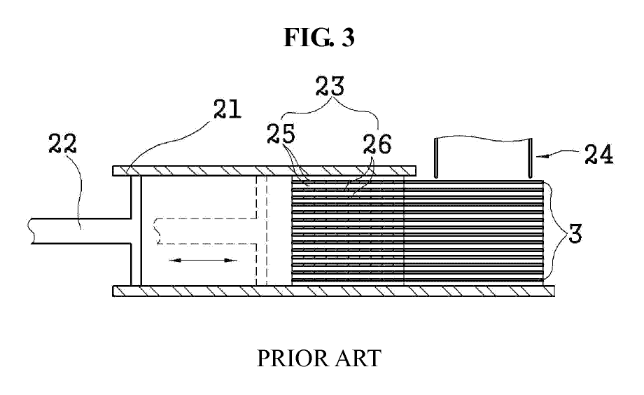

### DETAILED DESCRIPTION

Reference will be now made in detail to embodiments of the present invention with reference to the attached drawings. These embodiments are described in sufficient detail to enable those skilled in the art to practice the invention. Furthermore, it is to be understood that various embodiments of the present invention are different but there is no need to be mutually exclusive. For instance, it will be apparent to those skilled in the art that various modifications and variations can be made to the specific shape, structure and characteristics of the present invention without departing from the scope and spirit of the invention.

Moreover, it will be recognized by those skilled in the art that changes in position and arrangement of individual components in the embodiments of the present invention could be made without departing from the spirit and scope of the invention. Accordingly, the following detailed description is, therefore, not to be taken in a limiting sense, and if it is described properly, the scope of the present invention is defined only by the appended claims and their equivalents. In the drawings, the similar reference numerals designate the same or similar functions in many aspects.

Hereinafter, the embodiments of the present invention will be described in detail with reference to the attached drawings.

Before the description of the embodiment of the present invention, anode oxidation will be explained in brief.

Anodic Oxidation

Anode oxidation is an oxidation phenomenon occurring during an anode reaction, and using the anode oxidation, a process for growing an oxide membrane or a nitride membrane formed on a metal surface using the electrolytic reaction.

The anode oxidation may cause a microscopic change in the form of the metal surface or a change in crystal structure, and an example of the anode oxidation will be described as follows.

When DC current flows through an electrolyte, hydrogen is generated in cathode metal and oxygen is generated in anode metal (aluminum (Al) alloy, titanium (Ti), zinc (Zn), magnesium (Mg), niobium (Nb), and so on), and in this instance, the generated oxygen forms a metal oxide membrane while reacting with the cathode metal. In the above process, the electrolyte dissolves the metal oxide membrane finely, and in this instance, when the dissolution rate is in balance with the formation rate of the oxide membrane, uniform pores of 10 nm to 150 nm in diameter are formed on the anode metal surface.

When the pores are formed, the electrolyte and the DC current can be in contact with a metal substrate existing below the oxide membrane, and as a result, a membrane, which is still thicker than an oxide membrane formed by a spontaneous oxidation of the metal, can be formed.

The membrane formed through the above process has properties of various kinds according to process conditions, and a thicker membrane can be formed when an electrolyte of low density and high current or voltage are used.

The oxide membrane formed through the above has various thicknesses within a range of 0.5 μm to 150 μm. In the meantime, since the oxide membrane is high in corrosion resistance and frictional resistance and has uniform pores on the surface thereof, solutions such as dyes can permeate through the oxide membrane, and accordingly, the oxide membrane can be used for different purposes.

Presently, the most widely known standards of anode oxidation process are MIL-A-8625, and according to the standards, the anode oxidation process is classified into three aluminum anodization processes: an anode oxidation process; a sulfuric acid anodized process; and a sulfuric acid hard-anodized process. Physical and chemical properties of membranes formed through the three processes are different from one another.

Inorganic Membrane

Hereinafter, according to a first embodiment of the present invention, an inorganic membrane for a carrier of an exhaust gas purifier produced using the above-mentioned anode oxidation process will be described.

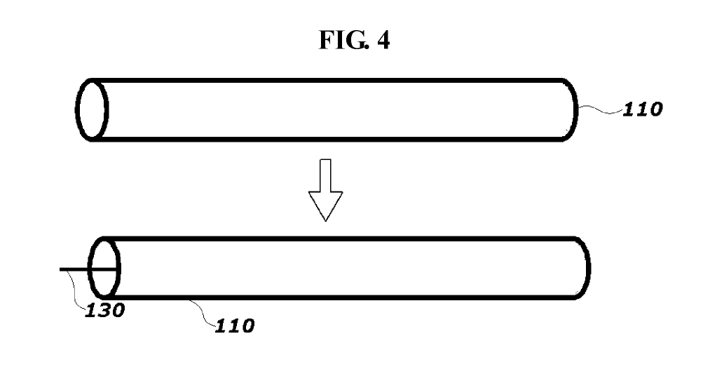

First, referring to FIG. 4, a production process of the inorganic membrane according to the embodiment of the present invention will be described.

The inorganic membrane according to the present invention is made of aluminum. First, prepare an empty aluminum pipe 110 of a cylindrical form, and degrease the inside and the outside of the prepared aluminum pipe. For the degreasing method, one of known methods may be used, and as an example, a degreasing method using acid solution may be used.

After that, carry out etching to the degreased aluminum pipe 110 to remove metal oxides contained in aluminum. For this, the base etching that exposes the aluminum pipe 110 to basic solution may be used. In the meantime, remove insoluble materials through desmut of the aluminum pipe 110 in slightly acid solution.

When the aluminum pipe 110 from which oxides and insoluble materials are removed is obtained, arrange an aluminum line 130 or an aluminum wire at the center of the aluminum pipe 110 to apply cathode current to the aluminum line 130 or the aluminum wire and anode current to the aluminum pipe 110 to thereby generate the anode oxidation.

For the anode oxidation, circulate the electrolyte into the aluminum pipe 110. It is preferable that a low-temperature sulfuric acid solution or basic solution is used as the electrolyte.

When the electrolyte is circulated, hydrogen is generated around the aluminum line 130 to which cathode current is applied, and oxygen is generated around the aluminum pipe 110 to which anode current is applied. In this instance, the generated oxygen reacts with the aluminum pipe 110, so that alumina which is aluminum oxide is gradually laminated on the inner wall of the aluminum pipe, and it causes a formation of an alumina membrane.

In this instance, like the described principle of anode oxidation, the electrolyte dissolves the alumina membrane finely, and when the dissolution speed is in balance with a growth speed of the alumina membrane, pores can be formed on the alumina membrane. The pores are uniform pores of 10 μm to 150 μm in diameter.

Through the principle of the anode oxidation, the thick alumina membrane having the uniform pores is formed on the inner wall of the aluminum pipe 110. As described above, the thickness of the membrane is about 0.5 μm to 150 μm.

In order to keep a mechanical strength of the alumina membrane and use it as a current collector, a portion of the aluminum pipe 110 can be reserved.

Through the above process, the porous aluminum membrane, namely, the inorganic membrane is formed.

Carrier Using Inorganic Membrane

Hereinafter, a method of producing a carrier using the inorganic membrane obtained through the above method will be described.

First, load a catalyst stock solution of jewelry series, which has activity to an exhaust gas reaction, on the inner wall and the outer wall of the inorganic membrane, which is the alumina membrane, to thereby form a catalytic layer. Alternatively, load a catalyst stock solution, such as a mixture solution of platinum or rhodium, to form the catalytic layer. It will be described in more detail.

After that, carry out firing under a flow of air at temperature of 450° C. for 12 hours to grow the crystal structure.

Since the produced carrier exists on the metal substrate in the form of a thin film and is more excellent in thermal conductivity than the ceramic carrier of a low heat capacity, it can easily reach a high temperature. Accordingly, the carrier according to the embodiments of the present invention can obtain various merits that can be obtained at high temperature, and maximize its performance.

In the meantime, the inorganic membrane is resistant to physical shock since the catalytic layer keeps the combination of the molecular level on the substrate.

Till now, as an example, aluminum was described as metal used for forming the inorganic membrane, but the present invention is not restricted to it, but any metal, which can form metal oxides, such as titanium or zirconium, can be used.

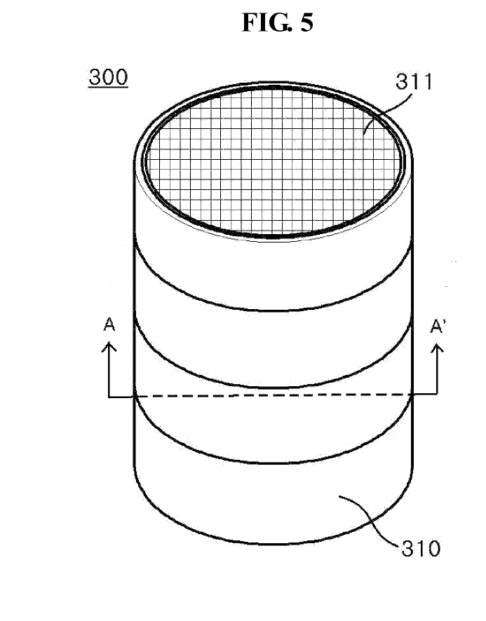

Referring to FIGS. 5 to 8, a production process of a carrier having an inorganic membrane according to a second embodiment of the present invention will be described.

Referring to FIGS. 5 to 8, in the first embodiment and the second embodiment, production methods and principles of the carrier having the inorganic membrane described in reference to FIG. 4 are substantially the same. However, in the second embodiment, the production method of the carrier having the inorganic membrane, which is available for mass-production, will be described.

FIG. 5 illustrates the carrier having the inorganic membrane according to the second embodiment of the present invention.

Referring to FIG. 5, the carrier 300 is aligned on an exhaust gas discharge passage of a vehicle, and includes at least one carrier module 310 laminated thereon. The carrier module 310 has an inorganic membrane which is maximized in surface area in order to enhance efficiency for purifying impurities of exhaust gas.

The carrier module 310 has a cylindrical outer form, and has a grid 311 formed inside the cylindrical carrier to a predetermined height in order to widen the surface area of the inorganic membrane for purifying exhaust gas.

The carrier 300 is mounted in a case (not shown) in a state where at least one carrier module 310 is laminated on the carrier 300, and then, used in an exhaust gas purifier.

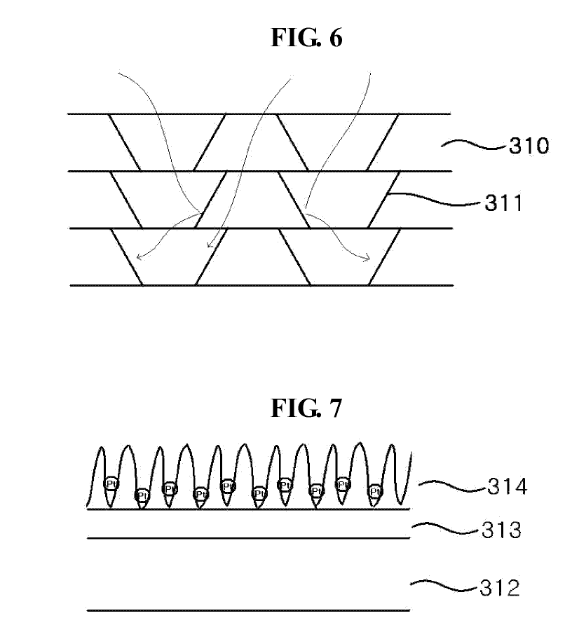

Since the cylindrical carrier module 310 is lower than that of the prior art and laminated on the carrier 300, it can maximize an area that exhaust gas moves and is in contact with the carrier module. Moreover, due to an influence of the grid 311 slantly formed inside the carrier module 310, a turbulent current is generated during the movement of exhaust gas, and it causes a more increase of the area that exhaust gas is in contact with the carrier module 310. It will be described in more detail referring to FIG. 6.

FIG. 6 is a sectional view taken along the line of A-A′ of FIG. 5.

Referring to FIG. 6, the grid 311 is formed in such a way as to be inclined at a predetermined angle from the height that the carrier module 310 is laminated. Compared with a case where the grid is piled up perpendicularly to the bottom side of the carrier module 310, the slantly formed grid 311 increases the purification efficiency not only by increasing the area that exhaust gas is in contact with the inorganic membrane but also by increasing a passage that exhaust gas moves inside the carrier 300 since exhaust gas generates the turbulent current due to the lash of exhaust gas against the grid 311 while exhaust gas passes through the carrier module 310.

FIG. 7 is an enlarged view of the surface of the grid shown in FIG. 6.

Referring to FIG. 7, on the surface of the grid 311, formed are a metal layer 312 forming a base, a transition layer 313 which is formed on the metal layer 312 and in which metals constituting the metal layer 312 and oxides of the metals coexist, and a porous ceramic film layer 314 formed on the transition layer 313. The metals constituting the metal layer may be aluminum, titanium or zirconium.

In the meantime, a platinum or rhodium (Rh) catalytic layer can be inserted between pores of the ceramic film layer 314. In this instance, the catalytic layer is formed by loading a catalyst stock solution, and the formed catalytic layer is dried to be used.

The platinum catalyst is used to convert CO into CO₂ of exhaust gas or resolve Hydro C into H₂O or CO₂. In the meantime, the rhodium catalyst is used to resolve NOX into N₂.

Conventionally, the platinum catalyst and rhodium catalyst are mixed, and then, inserted into the carrier to be used. But, in this case, the catalysts of different kinds act as obstructions during their chemical reactions, and it causes deterioration in exhaust gas reduction efficiency.

To solve the above problem, in the embodiment of the present invention, each of the carrier modules 310 illustrated in FIG. 5 has the catalytic layer of different kinds from each other, so that the problem that the catalytic layers act as obstructions during chemical reactions of heterogeneous catalysts can be solved.

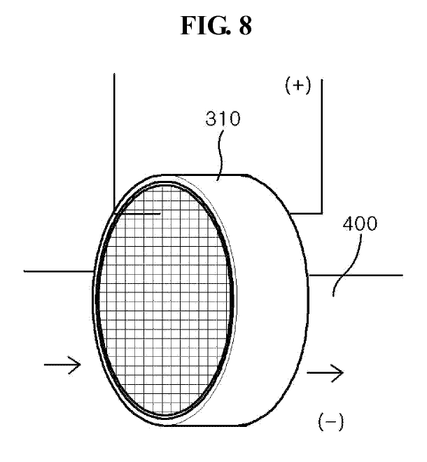

FIG. 8 illustrates a method of producing the carrier having the inorganic membrane according to another embodiment of the present invention.

As described above, degrease the inside and the outside of the metal layer 312, and then, carry out etching to the degreased metal layer 312 to thereby remove metal oxides contained in the metal layer 312.

Through the above, when the carrier module 310 that the metal layer 312, from which oxides and insoluble materials are removed, forms the outer skin is obtained, load the carrier module 310 at the center of a water tank, in which an electrolyte 400 is circulated by application of cathode current, and then, apply anode current to the carrier module 310 to thereby generate the anode oxidation.

It is preferable that a low-temperature sulfuric acid solution or basic solution is used as the electrolyte, and the inorganic membrane can be mass-produced in such a way that a plurality of the carrier modules 310 are loaded in the water tank simultaneously.

The catalytic layer can be formed in such a way that the carrier module 310 having the inorganic membrane formed through the above process is loaded in the catalyst stock solution, such as the mixture solution of platinum or rhodium. As described above, the catalytic layer acts as a catalyst during the exhaust gas purification.

After that, carry out firing at the temperature of 450° C. for 12 hours under a flow of air to thereby grow the crystal structure.

As described above, since the carrier module 310 is improved in its structure and can be mass-produced, the carrier according to this embodiment can not only achieve the exhaust gas purification efficiency through the above-mentioned inorganic membrane but also realize higher exhaust gas purification efficiency only by a small volume of the carrier, and can reduce the production costs through the mass-production.

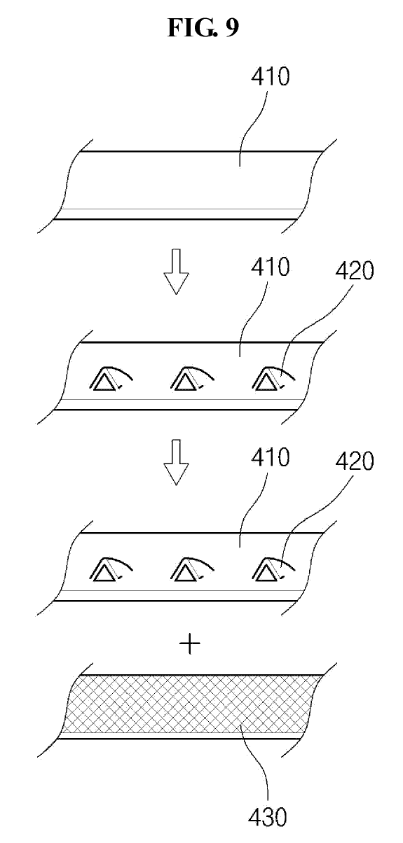

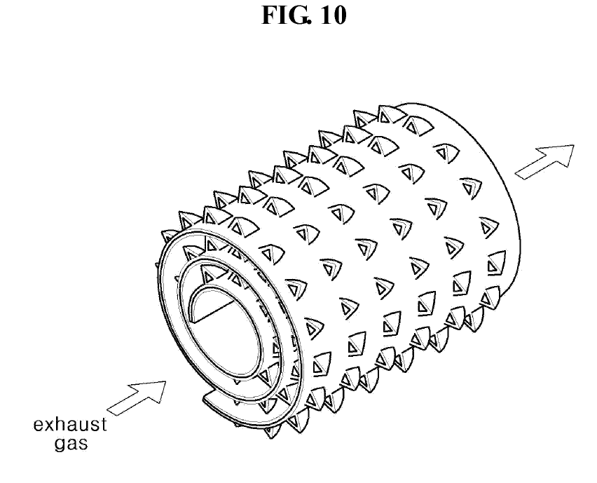

FIG. 9 illustrates a production process of a carrier having an inorganic membrane formed according to a further embodiment of the present invention, and FIG. 10 illustrates a structure of the carrier having the inorganic membrane formed by the method illustrated in FIG. 9.

Referring to FIGS. 9 and 10, in relation with the carrier 400, prepare a metal plate 410, and form holes 420 in a portion of the metal plate 410 through a press process. The holes 420 are similar in shape with a steam hole in the lid of a kettle. Form a sieve-shaped metal foam 430 for filtering impurities, such as dust contained in exhaust gas, beneath the metal plate 410.

Anodize the carrier to form an inorganic membrane, and load a catalyst stock solution of jewelry series, which has activity to an exhaust gas reaction, on the inner wall and the outer wall of the inorganic membrane to thereby form a catalytic layer. It is the same as the production process of the carrier illustrated in FIG. 4.

In the meantime, roll the carrier in a spiral form to form a cylindrical carrier structure. FIG. 10 illustrates the carrier structure produced through the above process.

The exhaust gas moves perpendicularly to the cylindrical carrier, namely, in such a way as to pass a circular section of the carrier, and in this process, passes through the plural holes 420. The exhaust gas introduced into the holes 420 passes through the metal foam 430 formed beneath the metal plate 410 in such a way that the impurities are filtered and only gas passes. The exhaust gas belonging to a turbulence group is complicated in its flow line and passes through the holes 420 and the metal foam 430 numerously during the process, whereby the purification efficiency can be maximized.

In the meantime, according to circumstances, the cylindrical carrier structure can be obtained through the steps of anodizing only the metal foam to form the inorganic membrane, forming the catalytic layer, and rolling the catalytic layer in the spiral form.

While the invention has been described with reference to particular matters, limited embodiments and drawings, it will be understood by those skilled in the art that the invention is not limited to the particular embodiments disclosed since the embodiments are disclosed in the present invention for better understanding of the present invention, but various changes may be made and equivalents may be substituted without departing from the scope of the invention.

Accordingly, it is obvious to those skilled in the art that the invention is not restricted to the embodiments described above, but that claims and all equivalents and modifications of the claims belong to the scope of the present invention.

1. A method of producing a carrier used for exhaust gas purification, comprising the steps of:
(a) applying anode current to each of carrier modules, and loading at least one of the carrier module in a water tank, in which an electrolyte is circulated and to which cathode current is applied; and
(b) forming a porous inorganic membrane on the outer skin of the carrier module to produce the carrier.

2. The production method according to claim 1, wherein before the step (a), further comprising the steps of: carrying out etching to the carrier module with solution to remove oxides existing in the carrier module; and carrying out desmut with an acid solution to remove insoluble materials existing in the carrier module.

3. The production method according to claim 1, wherein the electrolyte is a sulfuric acid solution or a basic solution.

4. The production method according to claim 1, further comprising the step of loading a catalyst stock solution on the inner wall and the outer wall of the carrier module to thereby form a catalytic layer.

5. The production method according to claim 4, wherein the catalytic layer is made of platinum or rhodium.

6. The production method according to claim 5, wherein the catalytic layers of different kinds are formed on every carrier module.

7. The production method according to claim 1, further comprising the step of laminating at least one of the carrier modules and mounting the at least one carrier module in a case.

8. A structure of a carrier used for exhaust gas purification, comprising:
a base structure; and
an inorganic membrane formed on the base structure and, arranged on an exhaust gas discharge passage, the inorganic membrane having a plurality of pores formed for purifying exhaust gas.

9. The structure of the carrier according to claim 8, wherein each of the pores is in the range of 10 μm to 150 μm in diameter.

10. The structure of the carrier according to claim 8, wherein the inorganic film is in the range of 0.5 μm to 150 μm in thickness.

11. The structure of the carrier according to claim 8, wherein the carrier structure is formed by laminating at least one carrier module in the carrier, the carrier module having a sieve-shaped grid.

12. The structure of the carrier according to claim 11, wherein the grid is formed inclinedly at a predetermined angle from a height direction of that the carrier module is laminate.

13. The structure of the carrier according to claim 12, wherein on the surface of the grid, formed are a metal layer forming a base, a transition layer which is formed on the metal layer and in which metals constituting the metal layer and oxides of the metals coexist, and a porous ceramic film layer formed on the transition layer.

14. The structure of the carrier according to claim 13, wherein a catalytic layer is inserted into the ceramic film layer.

15. The structure of the carrier according to claim 14, wherein the catalytic layer is made of platinum or rhodium.

16. The structure of the carrier according to claim 12, wherein the carrier module is made of aluminum, titanium or zirconium.
